(19) United States
(12) Patent Application Publication
(10) Pub. No.: US 2014/0146560 A1
(43) Pub. Date: May 29, 2014

(54) REFLECTION SHEET, BACKLIGHT UNIT, LIQUID CRYSTAL DISPLAY DEVICE, AND MANUFACTURING METHOD THEREOF

(71) Applicant: Samsung Display Co., Ltd., Yongin City (KR)

(72) Inventors: Dong Hoon KIM, Yongin-City (KR); Young Jun CHOI, Yongin-City (KR)

(73) Assignee: Samsung Display Co., Ltd., Yongin City (KR)

(21) Appl. No.: 13/937,788

(22) Filed: Jul. 9, 2013

(30) Foreign Application Priority Data
Nov. 23, 2012 (KR) 10-2012-0133697

(51) Int. Cl. F21V 7/05; F21V 8/00

(52) U.S. Cl. CPC F21V 7/05; G02B 6/0055; G02B 6/0065
USPC 362/606; 362/341; 264/1.9

(57) ABSTRACT

A reflection sheet of display backlighting unit is designed to be spaced apart by a predetermined gap distance from an overlying optical layer. However, the reflection sheet may inadvertently come into at least partial contact with the overlying optical layer. The reflection sheet is configured to avoid the creation of line contacts and wide area contacts with the optical layer. More specifically, the reflection sheet includes an upper skin layer having particles embedded therein. An average of surface roughness or height differences of the protrusions is caused to have a value of 15 μm or larger, and an interval between the adjacent protrusions is caused to be 200 μm or less.

### CROSS-REFERENCE TO RELATED APPLICATION

This application claims priority to and the benefit of Korean Patent Application No. 10-2012-0133697 filed in the Korean Intellectual Property Office on Nov. 23, 2012, the entire contents of which application are incorporated herein by reference.

### BACKGROUND

(a) Technical Field

The present disclosure of invention relates to a reflection sheet, a backlight unit, a liquid crystal display device, and a manufacturing method thereof.

(b) Description of Related Technology

Traditionally, video images were produced from a cathode ray tube (CRT) and image processing methods were developed for use with the then-existing and relatively bulky cathode ray tube. However, more recently, various “thin” (e.g., flat or curved) panel displays have been developed, such as for example liquid crystal displays (LCD's), plasma display panels (PDP's), organic light emitting diode (OLED) displays, electrowetting displays (EWD's), electrophoretic displays (EPD's), embedded micro cavity displays (EMD's), and nano crystal displays (NCD's).

Among these, the liquid crystal display (LCD) has been the one most in the limelight due to its advantages of allowing for reduced size and weight, and lowered power consumption. As a result, the liquid crystal display (LCD) has been mounted and used in almost every modern information processing device requiring a display device (e.g., laptop computers, flat panel TV's, etc.). In general, the liquid crystal display is one in which an electric field is formed through a liquid crystal material layer that is interposed between an upper and a spaced apart lower substrate. In one class of embodiments, the upper substrate is the one on which a wide-area common electrode is disposed and also a color filter layer composed of filter segments of various different colors (e.g., RGBW, where W stands for white). Also in this exemplary class of embodiments, the lower substrate is one on which an array of thin film transistors (TFT's), pixel electrodes, and the like are formed. In use, different potentials are applied to the respective pixel electrodes of the lower substrate while a common voltage is applied to the common electrode of the upper substrate to thereby change an arrangement of liquid crystal molecules in the intervening liquid crystal material layer. The optical properties of the device are such that corresponding transmittances of light (e.g., polarized light) are adjusted through the changes made to the arrangements of the liquid crystal molecules in various pixel areas to thereby display a desired image.

The liquid crystal display panel portion of a liquid crystal display assembly is designed as one that receives external light and as one which cannot emit light by itself. Accordingly, the liquid crystal display assembly typically includes a backlight unit for providing a backside illuminating light to the liquid crystal display panel.

There are different kinds of backlight units, including one that is classified as an edge type backlighting unit and one that is classified as a direct backside illuminating type of backlight unit based according to a position of a main light source. In the edge type backlight unit, the main light source is positioned in a side surface of a so-called, light guide plate (LGP) where the latter redirects the edge-provided light and distributes it for illuminating the backside of the display panel. Such an edge type backlighting unit may have a reflection sheet disposed under and spaced apart from its light guide plate (LGP) for purpose of increasing light usage efficiency.

If the reflection sheet is caused to come into direct contact with the light guide plate due to, for example; external pressure, wrinkling or heat warpage, a problem develops in that the points of direct contact may be viewed as extraordinarily bright image points and the quality of the intended image is degraded.

It is to be understood that this background of the technology section is intended to provide useful background for understanding the here disclosed technology and as such, the technology background section may include ideas, concepts or recognitions that were not part of what was known or appreciated by those skilled in the pertinent art prior to corresponding invention dates of subject matter disclosed herein.

### SUMMARY

The present disclosure of invention provides a reflection sheet that is not attached to, and is designed to ideally be spaced apart from an overlying light guide plate by a predetermined gap distance. The reflection sheet is provided in combination with a backlight unit, and a liquid crystal display device. A method of manufacturing the reflection sheet is also provided.

An exemplary embodiment provides a reflection sheet including: a main body; and an upper skin layer positioned on one surface of the main body and including a plurality of particles, in which irregular protrusions are formed on a surface of the upper skin layer, and where an average of surface roughness or height differences of the protrusions has a value of 15 μm or larger, and an interval between the adjacent protrusions has a value of 200 μm or less.

A maximum diameter of a majority of the plurality of particles may be 15 μm or larger.

The reflection sheet may further include a lower skin layer in the other surface of the main body.

A part of the plurality of particles may be positioned within the main body.

Reflection providing bubbles or globules having a lower refractive index than that of the bulk of the main body may be included in the main body.

An exemplary embodiment includes a backlight unit including: a light source configured to provide light; a light guide plate configured to guide the light provided from the light source; at least one optical film positioned at an upper side of the light guide plate; and the reflection sheet positioned at a lower side of the light guide plate and configured to reflect light to an upper portion, in which the reflection sheet includes: a main body; and an upper skin layer positioned in one surface of the main body and including a plurality of particles, and irregular protrusions are formed on a surface of the upper skin layer, and an average of surface roughness or height differences of the protrusions has a value of 15 μm or larger, and an interval between the adjacent protrusions has a value of 200 μm or less.

Bubbles or globules may be included within the main body for giving the main body reflective properties, and a maximum diameter of the plurality of the particles may be 15 μm or larger.

The backlight unit may further include a lower skin layer in the other surface of the main body.

A part of the plurality of particles may be positioned within the main body.

Another exemplary embodiment includes a display device including: a light receiving display panel; and a backlight unit configured to provide the light receiving display panel with light, in which the backlight unit includes: a light source configured to provide light; a light guide plate configured to guide the light provided from the light source; at least one optical film positioned at an upper side of the light guide plate; and a reflection sheet positioned at a lower side of the light guide plate and configured to reflect light to an upper portion, the reflection sheet includes: a main body; and an upper skin layer positioned in one surface of the main body and including a plurality of particles, and irregular protrusions are formed on a surface of the upper skin layer, and an average of surface roughness or height differences of the protrusions has a value of 15 μm or larger, and an interval between the adjacent protrusions has a value of 200 μm or less.

A maximum diameter of the plurality of particles may be 15 μm or larger.

The display device may further include a lower skin layer in the other surface of the main body.

A part of the plurality of particles may be positioned in the main body.

Bubbles may be included in the main body for giving the main body reflective properties.

The light receiving display panel may include a liquid crystal layer.

Still another exemplary embodiment includes a method of manufacturing a reflection sheet, including: disposing a first material for an upper skin layer including a plurality of particles at one side of a second material for a main body of the reflection sheet and coextruding the first and second materials; stretching the coextruded first and second materials; and providing gas to the stretched material and foaming the stretched material.

In the coextruding, a third material for a lower skin layer may be disposed at the other side of the second material for the main body of the reflection sheet and this may be coextruded together with the first and second materials.

In the foaming, bubbles may be formed in the material for the main body of the reflection sheet.

In the foaming, irregular protrusions may be formed on a surface of the material for the upper skin layer.

The method may further include examining surface roughness of the manufactured reflection sheet, in which the examining includes determining whether an average of height differences of the protrusions formed on the surface of the material for the upper skin layer has a value of 15 μm or larger, and whether an interval between the protrusions has a value of 200 μm or less may be examined.

As described above, the irregular protrusions are formed on the surface of the reflection sheet so as to have a height difference of the protrusions of 15 μm or larger and an interval between the protrusions of 200 μm or less, so that the reflection sheet is not in line-contact with the light guide plate, but is instead only in point-contact with the light guide plate in a case where the reflection sheet inadvertently comes into contact with the light guide plate, thereby achieving a more uniform luminance. Further, there is an advantage in that a separate manufacturing process is not required because the irregular protrusions are formed together when the reflection sheet is manufactured.

### BRIEF DESCRIPTION OF THE DRAWINGS

FIG. 1 is an exploded perspective view of a display device according to an exemplary embodiment of the present disclosure of invention.

FIG. 2 is a cross-sectional view of a backlight unit according to an exemplary embodiment.

FIG. 3 is a cross-sectional view of a reflection sheet according to an exemplary embodiment.

FIG. 4 is a picture of a cross section of a reflection sheet manufactured according to an exemplary embodiment.

FIGS. 5 and 6 are results of simulations of an appropriate height difference of protrusions of the reflection sheet through an experiment.

FIGS. 7 and 8 are results of simulations of an appropriate interval between protrusions of the reflection sheet through an experiment.

FIG. 9 is a flowchart illustrating steps of manufacturing a reflection sheet according to an exemplary embodiment.

FIG. 10 is a drawing illustrating a process of manufacturing a reflection sheet according to an exemplary embodiment.

### DETAILED DESCRIPTION

The present disclosure of invention will be described more fully hereinafter with reference to the accompanying drawings, in which exemplary embodiments are shown. As those skilled in the art would realize after reading the disclosure, the described embodiments may be modified in various different ways, all without departing from the spirit or scope of the present teachings.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

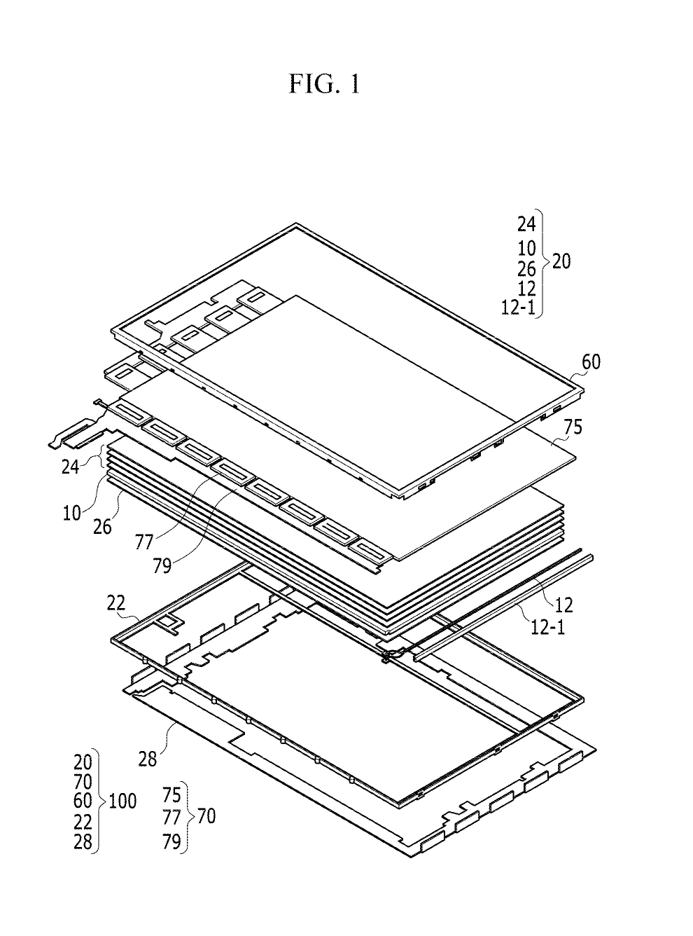

Hereinafter, a liquid crystal display device according to an exemplary first embodiment will be described in detail with reference to FIG. 1.

FIG. 1 is an exploded perspective view of a display device 100 according to an exemplary first embodiment.

The liquid crystal display device 100 according to the exemplary embodiment generally includes a backlight unit 20 (having elements referenced here as 10, 12, 12-1, 24 and 26) which is configured for supplying light to an overlying liquid crystal display panel assembly 70 (having elements referenced here as 75, 77, 79) where the latter is configured for displaying an image by using the supplied light. In addition, the liquid crystal display device 100 includes a top chassis 60 for fixing and supporting the backlight unit 20 and the liquid crystal display panel assembly 70. The LCD 100 further includes a mold frame 22, and a bottom chassis 28.

The backlight unit 20 provides light to the liquid crystal display panel assembly 70. The liquid crystal display panel assembly 70 which is positioned on top of the backlight unit 20 expresses grayscaled pixel areas by controlling intensity of light supplied from the backlight unit 20 and passed through the lower substrate. The color filters of the upper substrate add chrominance to the passed through light so that a desired color image is displayed.

First, the liquid crystal display panel assembly 70 will be described. It includes a liquid crystal display panel 75, one or more integrated circuit chips (IC chips) 77 and corresponding flexible printed circuit films (FPC) 79 for providing electric coupling between the mounted thereto IC chips 77, the panel 75 and external control circuits (not shown, but for example a timing control circuit).

The liquid crystal display panel 75 includes a TFT array substrate including an arrayed plurality of thin film transistors (TFTs), an upper substrate spaced apart above the TFT array substrate, and a liquid crystal material layer interposed between the TFT array substrate and the upper (e.g., common electrode) substrate. The IC chips 77 may be mounted directly on the TFT array substrate or on the flexible film circuits and used to control the liquid crystal display panel 75 (e.g., to drive so-called, data lines and/or gate lines of the panel).

The TFT substrate is a light-passing (e.g., transparent) and electrically insulating substrate on which the thin film transistors are formed in a matrix form, and respective data lines are connected to corresponding source terminals of the TFT's while respective gate lines are connected to corresponding gate terminals of the TFTs. Further, transparent pixel electrodes are formed for example of transparent indium tin oxide (ITO) and connected to corresponding drain terminals of the TFTs.

The data lines and the gate lines (not shown) of the liquid crystal display panel 75 are connected to the FPC films 79, so that when an electrical signal is input from the FPC films 79, the electrical signals are transmitted to the source terminals and the gate terminals of the TFTs, and the TFTs are selectively turned on or turned off according to scan signals applied to the gate terminals while data signals are applied through the data line so that, thus an image is defined by respective chargings and dischargings of the pixel electrodes. In other words, the FPC films 79 receive image defining signals from the outside of the liquid crystal display panel 75 and apply corresponding driving signals to each of the data lines and the gate lines of the liquid crystal display panel 75.

In the meantime, an upper substrate is oppositely disposed above the TFT substrate. The upper substrate is the substrate on which RGB color filters (or RGBW filters) are disposed and through which light passes so that predetermined colors may be expressed. The color filters may be formed by a thin film process. Also the transparent common electrode of the upper substrate may be formed of ITO and deposited on the color filters. When power is applied to the gate terminal and the source terminal of a TFT so that the thin film transistor is turned on, an electric field is formed between the pixel electrode and the common electrode of the upper substrate and charge is stored in a capacitor (C_{LC}) formed by the pixel electrode and its opposed part of the common electrode. An arrangement angle of liquid crystal interposed between the TFT substrate and the upper substrate is changed by the electric field, and light transmittance is changed according to the changed arrangement angle, so that a desired image is obtained.

The FPC films 79 convey image signals and scan signals for driving the liquid crystal display device 100, and a plurality of timing signals are received from the outside (from a timing control unit) for controlling the applying of the various signals at an appropriate times (e.g., for coordinating the applying of the data line image signals and the gate line scan signals respectively.

A structure of the liquid crystal display panel 75 according to the exemplary embodiment has been described. However, liquid crystal display panels 75 according to various exemplary embodiments may be used differently from the aforementioned exemplary embodiment. For example, the common electrode and/or the color filters may be instead be formed on the TFT array substrate. Further, the liquid crystal display device 100 may further have additional printed circuit boards, and the printed circuit boards and the TFT substrate may be connected to each other by the flexible printed circuit films.

The backlight unit 20 is configured for providing the liquid crystal display panel 75 with uniform light is included under the liquid crystal display panel assembly 70 to be accommodated on the bottom chassis 28.

The top chassis 60 is configured for preventing the liquid crystal display panel assembly 70 from being separated from the bottom chassis 28. During assembly, the FPC board 79 is bent to the outside of the mold frame 22 and is included on the liquid crystal display panel assembly 70.

The liquid crystal display device 100 includes one or more light sources 12 (e.g., LED's) that are fixed to the mold frame 22 and are configured for supplying light to the liquid crystal display panel assembly 70. The device 100 further includes a substrate 12-1 for supplying electrical power signals to the light sources 12, a light guide plate (LGP) 10 for re-directing and guiding light emitted from the light sources 12 to supply the light to underneath the liquid crystal display panel assembly 70, a reflection sheet 26 positioned on an entire surface of a lower portion of the light guide plate 10 configured for reflecting light back up to the panel assembly 70, and one or more optical sheets 24 configured for providing desired luminance characteristics (e.g., uniformity) of the light from the light source 12 to provide the liquid crystal display panel assembly 70 with the desired backlighting luminance characteristics. The optical sheets 24 may include at least one of various kinds of optical sheets, such as a prism sheet, a luminance improvement film for improving luminance or a prism structure and a diffuser sheet for uniformly diffusing light. In the exemplary embodiment of FIG. 1, an edge-lighting fluorescent lamp, such as a CCFL, is used as the light source 12, but light emitting diodes (LED's; white and/or colored) may be used depending on an exemplary embodiment. Further, the light source(s) 12 is the edge type backlight unit 20 is positioned at least one edge surface of the light guide plate 10.

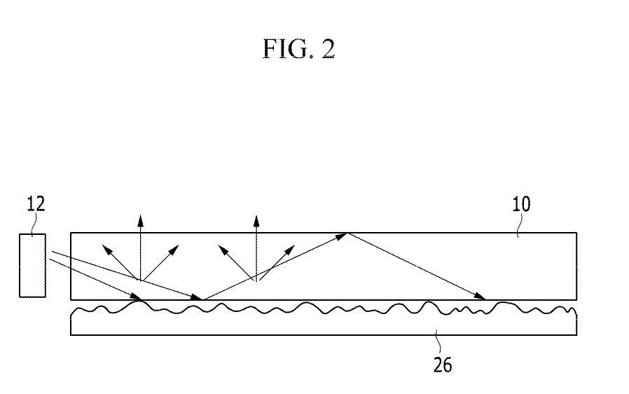

The reflection sheet 26 according to the exemplary embodiment is provided with irregular protrusions formed on a surface thereof as schematically illustrated in FIG. 2. The irregular protrusions may be configured for scatter-wise reflecting incident light so that the reflected light is provided more uniformly to the liquid crystal display panel assembly 70.

FIG. 2 is a cross-sectional view of the backlight unit according to the exemplary embodiment.

FIG. 2 illustrates only partial constituent elements of the backlight unit 20, and the illustrated constituent elements are the light source(s) 12, the light guide plate (LGP) 10, and the reflection sheet 26.

The light rays emitted from the light source(s) 12 enter through an adjacent sidewall surface of the light guide plate 10 and then pass through the light guide plate 10 to be mostly evenly transmitted to a display area, while some of the this light is reflected from the reflection sheet 26 to also be transmitted toward the backside of the liquid crystal display panel assembly 70 which is positioned on the upper side of the light guide plate (LGP) 10.

The reflection sheet 26 is positioned under the light guide plate 10, and may be in point-contact with the light guide plate 10 at some places while otherwise being spaced apart from the light guide plate 10 by a predetermined distance. Even though in some places the reflection sheet 26 is in point contact with the light guide plate 10, the irregular protrusions which are formed on the upper surface of the reflection sheet 26 are configured to minimize the area of direct contact with the bottom side of the light guide plate 10 so as to thus minimize the point contact effect and otherwise keep the other reflective portions of the reflection sheet 26 spaced apart on average by the desired predetermined distance.

When the reflection sheet 26 is in line-contact or in wide-area surface-contact with the light guide plate 10, the corresponding lines or wide-area surface portions of direct contact portion are seen as being significantly brighter than other portions, so that there occurs a problem in that a user may view the line-contact or wide-area surface-contact portions as being unusually bright. However, in accordance with the present disclosure, the irregular protrusions which are formed on the upper surface of the reflection sheet 26 are configured to minimize the area of direct contact with the bottom side of the light guide plate 10 so as to limit such contact to only scattered small points of contact such that; accordingly, the light provided by the backlight unit 20 will be perceived as being relatively even (uniform) over the entire display area even though the reflection sheet 26 might be in contact with the light guide plate 10.

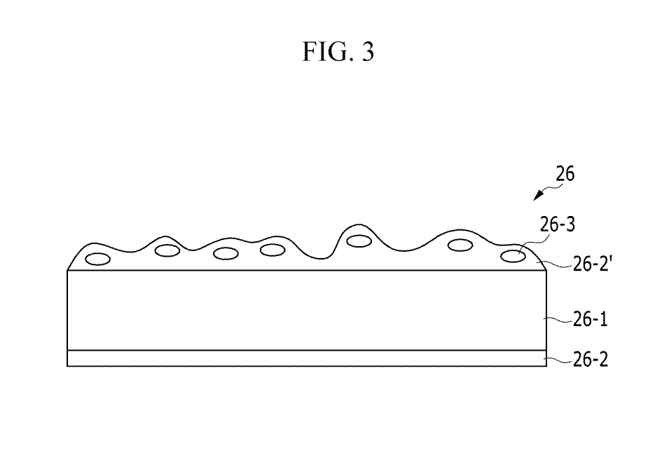

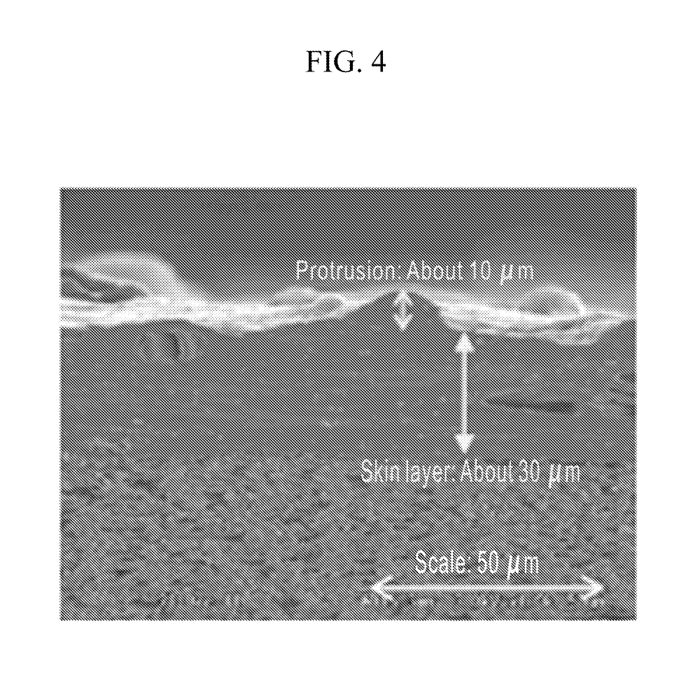

A more detailed cross sectional view of the reflection sheet 26 is illustrated in FIG. 3, and a micrograph picture of the cross section is illustrated in FIG. 4.

FIG. 3 is a cross-sectional view of the reflection sheet according to the exemplary embodiment, and FIG. 4 is a micrograph picture of a cross section of the reflection sheet manufactured according to the exemplary embodiment.

The reflection sheet 26 according to the exemplary embodiment includes a main or bulk body portion 26-1, a lower skin layer 26-2, and an upper skin layer 26-2′. The upper skin layer 26-2′ includes particles 26-3 embedded therein for providing a surface roughness characteristic that favors point contact with the overlying light guide plate (LGP) 10 as opposed to line contact or wide-area contact.

The main body 26-1 has a characteristic of reflecting light, and may include bubbles (see FIG. 4). The bubbles (e.g., voids, regions of low refractive index; not shown) enable the main body 26-1 to reflect light. The main body 26-1 may be formed of a synthetic resin, where the type of synthetic resin is not limited, but where PolyEthylene Terephthalate (PET) may be used as an example.

The lower skin layer 26-2 and the upper skin layer 26-2′ are made of materials that serve to protect the main body 26-1 from scratching, chemical corrosion, etc., and the upper skin layer 26-2′ has a surface roughness characteristic that favors point contact with the overlying light guide plate (LGP) 10 as opposed to line contact or wide-area contact in the case where the reflection sheet 26 comes into undesired contact with the light guide plate 10.

The lower skin layer 26-2 and the upper skin layer 26-2′ may be formed of a synthetic resin, and for example, the lower skin layer 26-2 and the upper skin layer 26-2′ may be formed of an acryl resin or a same or similar PET as that of the main body 26-1. The lower skin layer 26-2 and the upper skin layer 26-2′ may be formed of the same materials as each other or of different materials. The lower skin layer 26-2 and the upper skin layer 26-2′ do not include bubbles, so that the lower skin layer 26-2 and the upper skin layer 26-2′ do not have a characteristic of reflecting light due to interface of a high index of refraction (n_{HI}) with a region of lower index (n_{LOW}).

The upper skin layer 26-2′ includes the particles 26-3 which cause it to have the distribution of uneven protrusions extending from the upper surface thereof. The protrusions may be generated by the upper skin layer 26-2′ covering the particles 26-3. The particles 26-3 may have a bead structure formed of a transparent resin, and various resins may be used. For example, the bead-like particles 26-3 may cured (hardened) first and deposited as such on the surface of the main body 26-1 and then the resin of the upper skin layer 26-2′ may be deposited as a constant thickness film and cured.

Depending on the exemplary embodiment, the particles 26-3 may be alternatively or additionally included in the main body 26-1. Further, the particles 26-3 may be additionally included in the lower layer 26-2, and corresponding protrusions (not shown) may also be formed on the surface of the lower skin layer 26-2.

When the reflection sheet 26 is in point-contact with the light guide plate 10 (but not in line or wide area contact) due to the protrusions formed on the surface of the upper skin layer 26-2′, the reflection sheet 26 does not exhibit lines of unusual brightness or wide areas of unusual brightness even though the reflection sheet 26 is in contact with the light guide plate 10. To this end, the protrusions on the surface of the reflection sheet 26 need to meet a predetermined numerical value range in terms of size and distribution.

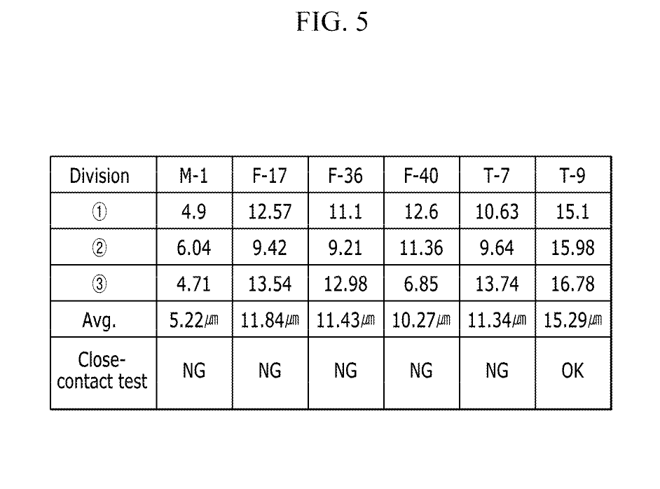

A desired predetermined numerical value range will be described where reference to FIGS. 5 to 8.

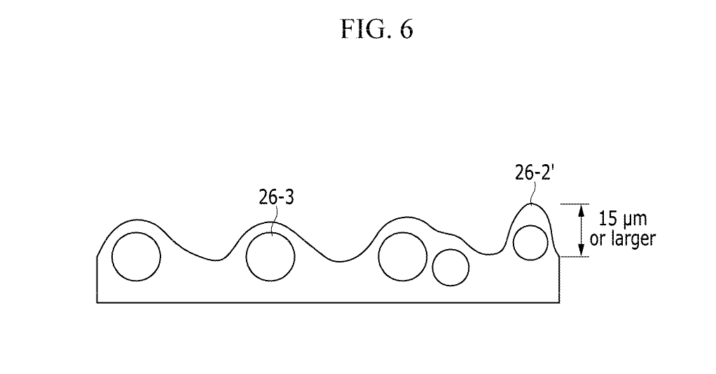

First, a height characteristic of the protrusion will be described by using FIGS. 5 and 6.

FIGS. 5 and 6 are results of simulations of an appropriate height difference of protrusions of the reflection sheet through an experiment.

A table of FIG. 5 shows results obtained by measuring difference values between maximum heights and minimum heights of protrusions at three sample points (1), (2), and (3) in cross tabulation with a total of six exemplary embodiments denoted as M-1, F-17, F-36, F-40, T-7, and T-9 and then calculating average values Avg for each embodiment and its respective three sample points. In the table of FIG. 5, NG represents a case in which there is a possibility in that luminance is not uniform due to a line-contact or wide area surface contact characteristic, and OK represents a case in which the only the point-contact is formed.

According to the results of the experiment of an appropriate value of the height difference of the protrusions on the surface of the reflection sheet 26 according to the respective exemplary embodiments based on the average values Avg., when the average value Avg. is at least 15 μm as shown in the case of exemplary embodiment T-9 (the last one on the right), the reflection sheet 26 and the light guide plate 10 have only the point-contact characteristic even though the reflection sheet 26 is in contact with the light guide plate 10.

That is, and as can be seen from FIG. 5, in the case where the height differences between the protrusions of the sample areas can be relatively large (e.g., embodiment F-14 where 12.60−6.85=5.75) or in the case where the heights of the protrusions are relatively small, (e.g., embodiment M-1 where the Avg. is 5.22) there is a high probability that the reflection sheet 26 will form a line-contact or a wide-area contact with the light guide plate 10, so that the average value Avg. of protrusion height needs to be about 15 μm or larger and the difference between heights at the sample points is preferably small. In the meantime, a maximum value of the height difference of the protrusions is not limited to, but is preferably smaller than the thickness of the designed separation gap between the reflection sheet 26 and the LGP 10 of the backlight unit 20.

FIG. 6 illustrates a result of this analysis of the simulation of FIG. 5.

More specifically, a maximum diameter of at least a majority of the particles 26-3 included in the reflection sheet 26 should be 15 μm or larger so as to provide the desired heights of the protrusions, but should be smaller than the deposited film thickness of the upper skin layer 26-2′ so that the irregularity providing particles 26-3 do not stick out of the top of the deposited film thickness of the upper skin layer 26-2′. In order for the protrusions to have a value of 15 μm or larger, the aforementioned particles 26-3 having maximum diameters greater than 15 μm are used. Additionally, in order to prevent the used particles 26-3 from sticking out beyond the top surface of the upper skin layer 26-2′, the deposited film thickness of the upper skin layer 26-2′ is selected to be greater than the maximum diameters of the used particles 26-3.

Further, the values of FIG. 5 may be obtained through measurement of surface roughness. Even when the values of FIG. 5 are measured through the surface roughness, the average value may be 15 μm or larger.

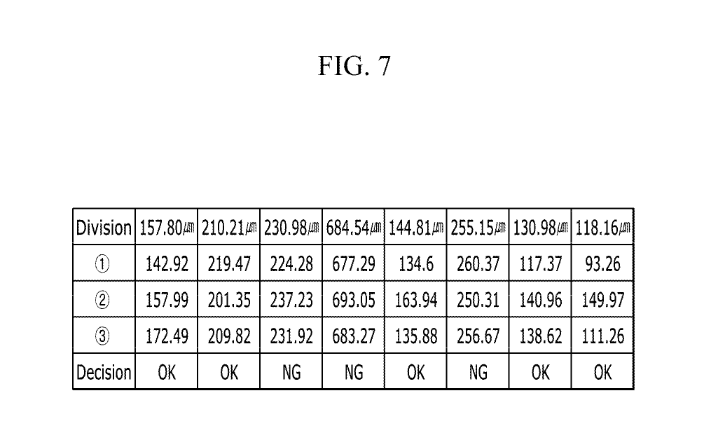

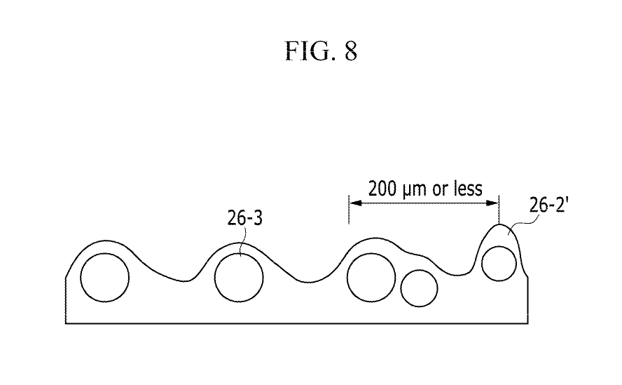

In the meantime, hereinafter, a characteristic of a lateral interval between the protrusions will be described by using FIGS. 7 and 8.

FIGS. 7 and 8 are results of simulations of appropriate different average intervals between the protrusions of the reflection sheet through an experiment using the OK embodiment T-9 of FIG. 5.

In a table of FIG. 7, intervals between the protrusions at respective three sample points (1), (2), and (3) for a total of eight exemplary embodiments of respective different average intervals were measured, and average values of the measurement results are represented in the topmost (first) row. In Table of FIG. 7, NG represents a case in which there is a fair possibility in that luminance is not uniform due to a line-contact or wide area surface contact characteristic, and OK represents a case in which only the point-contact is formed.

According to FIG. 7, when the average interval between the protrusions has a value of 200 μm or less, the reflection sheet 26 and the light guide plate 10 have a characteristic of only the point contact being usually formed even though the reflection sheet 26 is in contact with the light guide plate 10.

That is, it can be seen that when the interval between the protrusions is large, there is a high possibility in that the reflection sheet 26 is in line-contact with the light guide plate 10, so that the interval needs to be 200 μm or less. In the meantime, a minimum value of the interval between the protrusions is not limited, but should be larger than a maximum diameter of the used particles 26-3.

FIG. 8 illustrates a result of the analysis provided for the simulation of FIG. 7.

Comprehensively investigating FIGS. 5 to 8, the protrusions on the surface of the upper skin layer 26-2′ of the reflection sheet 26 should have an average of the surface roughness or the height differences of 15 μm or larger, and the interval between the protrusions should be 200 μm or less, so that the light guide late 10 is only in point-contact with the reflection sheet 26 (but not in line or wide area contact) even though the light guide late 10 is in contact with the reflection sheet 26, and as a result, the backlight unit 20 may uniformly provide light to the display area without displaying unusually bright lines or areas due to the contact.

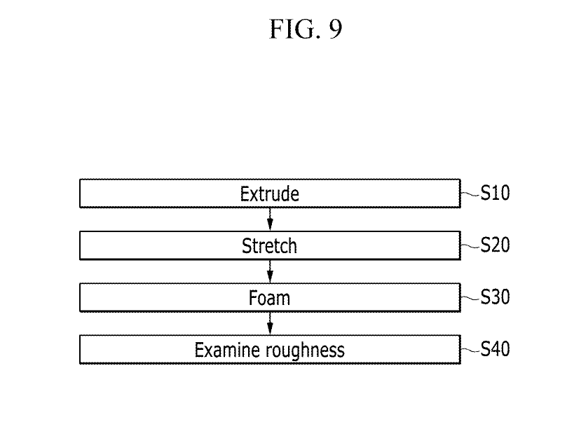

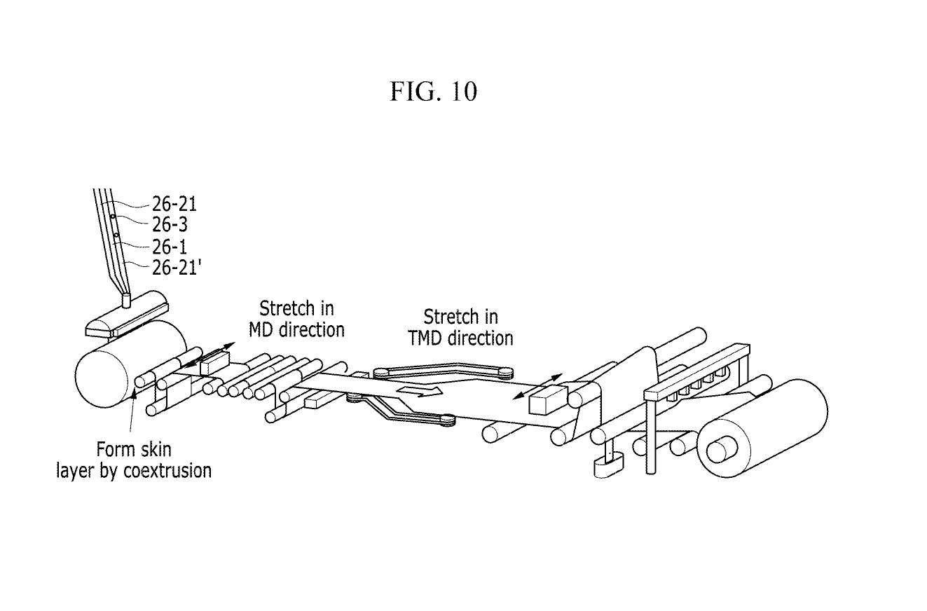

Hereinafter, a method of manufacturing the reflection sheet 26 according to an exemplary embodiment will be described with reference to FIGS. 9 and 10.

In the reflection sheet 26 according to the exemplary embodiment, the protrusions are not separately formed on the surface through an additional process after the reflection sheet 26 is manufactured, but rather the protrusions are formed together with the bulk body when the reflection sheet 26 is manufactured.

First, the method of manufacturing the reflection sheet 26 according to the exemplary embodiment will be described for each step with reference to FIG. 9.

FIG. 9 is a flowchart illustrating steps of manufacturing the reflection sheet according to the exemplary embodiment.

Respective materials 26-21 and 26-21′ (could be the same) for the respective lower skin layer 26-2 and for the upper skin layer 26-2′ are provided with each already including the irregularity providing particles 26-3. These respective material layers, 26-21 and 26-21′ are disposed at opposed sides of a further provided material layer 26-11 for forming the bulk or main body 26-1 of the reflection sheet, where these three material layers are disposed so that they can be coextruded (step S10).

The material 26-11 for the main body of the reflection sheet is formed of a synthetic resin, and a type of synthetic resin is not limited, but PET may be used as an example. The materials 26-21 and 26-21′ for the skins of the reflection sheet may be free of low index (n_{LOW}) bubbles, differently from the main body 26-1 of the reflection sheet.

The material 26-21 for the lower skin layer and the material 26-21′ for the upper skin layer may be formed of a synthetic resin, and for example, the material 26-21 for the lower skin layer and the material 26-21′ for the upper skin layer may be formed of an acryl resin different from the material 26-11 for the main body of the reflection sheet or the same PET as the material 26-11 for the main body of the reflection sheet. Further, the material 26-21 for the lower skin layer and the material 26-21′ for the upper skin layer may be the same material or different materials.

The particles 26-2 are mixed in the material 26-21′ for the upper skin layer, and the particles 26-3 may be a beads formed of a cured transparent resin.

The coextrusion is performed so that the material 26-21 for the lower skin layer 26-2 is positioned at one side of the material 26-11 for the main body 26-1 of the reflection sheet, and the material 26-21′ for the upper skin layer 26-2′ including the particles 26-3 is positioned at the opposed other side.

According to the exemplary embodiment, the material 26-11 for the main body 26-1 of the reflection sheet, the material 26-21 for the lower skin layer 26-2, and the material 26-21′ for the upper skin layer 26-2′ may be the same material (except that the skins do not have bubbles), and the particles 26-3 may be positioned in the material 26-11 for the main body 26-1 of the reflection sheet or the material 26-21 for the lower skin layer 26-2, in addition to the material 26-21′ for the upper skin layer 26-2′.

Then, the extruded three-layered materials are stretched (S20). The extruded materials are stretched in a movement direction (MD direction) and a direction (TD direction) perpendicular to the movement direction, respectively.

The stretching step (and mechanism therefor) is illustrated in detail in FIG. 10.

FIG. 10 is a drawing illustrating a process of manufacturing a reflection sheet according to an exemplary embodiment.

As illustrated in FIG. 10, the coextruded material heads in a predetermined direction through a roller, and the coextruded material is first stretched in the direction (MD direction) that is perpendicular to the one in which the material moves, and then is stretched in the direction (TMD direction) perpendicular to the direction (to the MD direction).

As a result, the coextruded material is formed in a film type, and the film formed as described above may be wound around the roller (right side of FIG. 10) to be stored and used as the process continues.

Then (referring back to FIG. 9), the stretched material is foamed (S30).

The foaming process is performed by providing a gas at least to a middle bulk portion of the stretched material. As a result, bubbles are formed inside the material 26-11 for the main body 26-1 of the reflection sheet, and the gas is foamed so that the protrusions are formed on the surface of the material 26-21′ for the upper skin layer 26-2′.

The bubbles are formed inside the material 26-11 for the main body 26-1 of the reflection sheet, so that the main body 26-1 of the reflection sheet is completed, and has a characteristic in that light is reflected by the bubbles.

Further, the material 26-21′ for the upper skin layer 26-2′ has an uneven surface by the particles 26-3, and the irregular protrusions are further completed on the surface by the foaming process.

According to the exemplary embodiment, the foaming process for foaming the bubbles inside the material 26-11 for the main body 26-1 of the reflection sheet and the foaming process for forming the protrusions on the surface of the material 26-21′ for the upper skin layer 26-2′ may be separately performed. In this case, the foaming process for forming the bubbles may be first performed, and the foaming process for forming the protrusions on the surface may be performed later.

According to the exemplary embodiment, the uneven protrusions may be formed on the lower skin layer 26-2. When it is not necessary to form the protrusions on the lower skin layer 26-2, a process for planarizing the surface by pressurizing the surface from a side of the lower skin layer 26-2 may be further performed.

The reflection sheet 26 manufactured by the aforementioned process should have an average of a height difference of the protrusions of 15 μm or larger, and a value of an interval between the protrusions of 200 μm or less, considering a characteristic of the contact with the light guide plate 10.

In order to confirm this, a step of examining roughness of the surface may be additionally performed (S40) after the foaming and failing product (or batches thereof) may be discarded. In the examination of the surface roughness, the height difference of the protrusions and the interval between the protrusions are examined.

The examination of the surface roughness may be performed by a total inspection, but may be performed by inspecting a partial sample of each respective production batch.

The manufacturing method according to the exemplary embodiment of FIG. 9 has an advantage in that the particles 26-3 included in the upper skin layer 26-2′ and the protrusions on the surface of the reflection sheet 26 are manufactured together when the reflection sheet 26 is manufactured. This does not require an additional process for separately attaching a bead to the surface of the reflection sheet 26, thereby simplifying the manufacturing process and decreasing a time and an expense required to manufacture the reflection sheet 26.

While this disclosure of invention has been described in connection with what is presently considered to be practical exemplary embodiments, it is to be understood that the teachings are not limited to the disclosed embodiments, but, on the contrary, the teachings are intended to cover various modifications and equivalent arrangements included within the spirit and scope of the teachings.

<Description of symbols>

| | |
|---|---|
| 10: Light guide plate | 100: Liquid crystal display device |

| | |
|---|---|
| 12: Light source | 20: Backlight unit |
| 22: Mold frame | 24: Optical sheet |

| | |
|---|---|
| 26: Reflection sheet | 26-1: Main body |

26-11: Material for main body of reflection sheet
26-2: Lower skin layer

| | |
|---|---|
| 26-21: Material for lower skin layer | 26-2′: Upper skin layer |
| 26-21′: Material for upper skin layer | 26-3: Particle |
| 28: Bottom chassis | 60: Top chassis |

| | |
|---|---|
| 70: Display panel assembly | 75: Liquid crystal display panel |
| 77: IC chip | 79: Flexible printed circuit board |

What is claimed is:

1. A reflection sheet, comprising:
a main body; and
an upper skin layer positioned on an upper surface of the main body, the upper skin layer comprising a plurality of particles,
wherein irregular protrusions are formed on a top surface of the upper skin layer due to the presence of the particles,
wherein an average of surface roughness or height differences of the protrusions has a value of 15 μm or larger, and
wherein an interval between the adjacent protrusions has a value of 200 μm or less.

2. The reflection sheet of claim 1, wherein:
the average of surface roughness or height differences of the protrusions has a value not more than a predetermined gap distance designed for spacing apart of the reflection sheet from a optical processing layer,
the interval between the adjacent protrusions has a value not less than a maximum diameter of a majority of the particles, and
the maximum diameter of at least the majority the particles is 15 μm or larger but not more than the predetermined gap distance.

3. The reflection sheet of claim 2, further comprising:
a lower skin layer disposed on a lower surface of the main body, the lower surface being opposed to the upper surface of the main body.

4. The reflection sheet of claim 2, wherein:
at least some of the particles are disposed within the main body.

5. The reflection sheet of claim 1, wherein:
the main body has reflection providing globules or bubbles defined therein.

6. A backlight unit, comprising:
a light source configured to provide light;
a light guide plate configured to guide the light provided from the light source;
at least one optical film positioned at an upper side of the light guide plate; and
a reflection sheet positioned at a lower side of the light guide plate and configured to reflect light to an upper portion, wherein the reflection sheet is designed for preferably being spaced apart from the lower side of the light guide plate by a predetermined gap distance and
wherein the reflection sheet comprises:
a main body; and
an upper skin layer positioned on an upper surface of the main body, the upper skin layer comprising a plurality of particles,
wherein irregular protrusions are formed on a top surface of the upper skin layer due to the presence of the particles,
wherein an average of surface roughness or height differences of the protrusions has a value of 15 μm or larger, and
wherein an interval between the adjacent protrusions has a value of 200 μm or less.

7. The backlight unit of claim 6, wherein:
the main body has reflection providing globules or bubbles defined therein, and
the average of surface roughness or height differences of the protrusions has a value not more than a predetermined gap distance designed for spacing apart of the reflection sheet from the light guide plate,
the interval between the adjacent protrusions has a value not less than a maximum diameter of a majority of the particles, and
the maximum diameter of at least a majority of the particles is 15 μm or larger.

8. The backlight unit of claim 7, further comprising:
a lower skin layer disposed on the other surface of the main body.

9. The backlight unit of claim 7, wherein:
a part of the plurality of particles is disposed within the main body.

10. A display device, comprising:
a light receiving display panel; and
a backlight unit configured to provide the light receiving display panel with light,
wherein the backlight unit comprises:
a light source configured to provide light;
a light guide plate configured to guide the light provided from the light source;
at least one optical film positioned at an upper side of the light guide plate; and
a reflection sheet positioned at a lower side of the light guide plate and configured to reflect light to an upper portion of the light guide plate,
the reflection sheet comprises:
a main body; and
an upper skin layer positioned on an upper surface of the main body, the upper skin layer comprising a plurality of particles,
wherein irregular protrusions are formed on a top surface of the upper skin layer due to the presence of the particles,
wherein an average of surface roughness or height differences of the protrusions has a value of 15 μm or larger, and
wherein an interval between the adjacent protrusions has a value of 200 μm or less.

11. The display device of claim 10, wherein:
the average of surface roughness or height differences of the protrusions has a value not more than a predetermined gap distance designed for spacing apart of the reflection sheet from the light guide plate,
the interval between the adjacent protrusions has a value not less than a maximum diameter of a majority of the particles, and
the maximum diameter of a majority of the plurality of particles is 15 μm or larger.

12. The display device of claim 11, further comprising:
a lower skin layer disposed on the other surface of the main body.

13. The display device of claim 11, wherein:
a part of the plurality of particles is positioned in the main body.

14. The display device of claim 10, wherein:
the main body has reflection providing globules or bubbles defined therein.

15. The display device of claim 10, wherein:
the light receiving display panel comprises a liquid crystal layer.

16. A method of manufacturing a reflection sheet, comprising:
disposing a first material to be used for forming an upper skin layer comprising a plurality of particles at one side of a second material to be used for forming a main body of the reflection sheet and coextruding the first and second materials;
stretching the coextruded material;
providing gas to the stretched material; and
foaming the stretched material.

17. The method of claim 16, wherein:
prior to the coextruding, a third material to be used for forming a lower skin layer is disposed at the other side of the second material for the main body of the reflection sheet and the third material is coextruded together with the first and second materials.

18. The method of claim 16, wherein:
in the foaming, bubbles are formed in the material for the main body of the reflection sheet.

19. The method of claim 18, wherein:
in the foaming, irregular protrusions are formed on a surface of the material for the upper skin layer due to the presence of the particles.

20. The method of claim 16, further comprising:
examining surface roughness of the manufactured reflection sheet,
wherein in the examining includes determining whether an average of height differences of the protrusions formed on a surface of the material for the upper skin layer has a value of 15 μm or larger, and whether an interval between the protrusions has a value of 200 μm or less.
